(19) United States
(12) Patent Application Publication
(10) Pub. No.: US 2013/0027259 A1
(43) Pub. Date: Jan. 31, 2013

(54) Traveling Wave Excitation Antenna And Planar Antenna

(71) Applicants: Takaaki Fujita, Sanda-shi (JP); Takeshi Okunaga, Sanda-shi (JP); Eisuke Hayakawa, Kobe-shi (JP)

(72) Inventors: Takaaki Fujita, Sanda-shi (JP); Takeshi Okunaga, Sanda-shi (JP); Eisuke Hayakawa, Kobe-shi (JP)

(73) Assignees: FUJITSU TEN LIMITED, Kobe-shi (JP); NIPPON PILLAR PACKING CO., LTD., Osaka (JP)

(21) Appl. No.: 13/559,686

(22) Filed: Jul. 27, 2012

(30) Foreign Application Priority Data
Jul. 29, 2011 (JP) 2011-166709

(51) Int. Cl. H01Q 11/04

(52) U.S. Cl. 343/731

(57) ABSTRACT

An object is to suppress radiation of a cross polarized wave by a microstrip antenna to improve cross polarization discrimination of the traveling wave excitation antenna. A microstrip antenna wherein: a feed line 21 through which a traveling wave propagates, and a radiating element 22 that is excited by the traveling wave are formed on a dielectric substrate 1, and wherein: the radiating element 22 has a radiating part 22A for radiating a co-polarization wave, and an open stub 22B that has a stub length 22A substantially equal to λg/4 and that extends from the radiating part toward a cross polarization direction. Therefore, without changing an element width Lb of the radiating element 22, radiation of a cross polarized wave by the radiating element 22 can be suppressed to improve cross polarization discrimination.

### BACKGROUND OF THE INVENTION

1. Field of the Invention

The present invention relates to a traveling wave excitation antenna and a planar antenna, and more particularly, to improvement of a traveling wave excitation antenna provided with a radiating element excited by a traveling wave that propagates through a feed line, for example, to improvement of a planar antenna such as a microstrip antenna that transceives a microwave or milliwave.

2. Description of the Related Art

In recent years, as an automotive radar for monitoring a surrounding environment of an automobile, a milliwave radar is being into practical use. The milliwave radar uses a milliwave having a wavelength of 1 to 10 mm as a radar signal, and can realize a radar system having relatively high resolution. Also, the milliwave radar can employ, as a transceiving antenna, a microstrip antenna that makes it easy to downsize the system in size and weight and produces a large cost reduction effect. From such circumstances, for the microstrip antenna used for the automotive milliwave radar, various proposals have been made (e.g., Japanese Unexamined Patent Publication No. 2001-44752).

FIG. 21 is a diagram illustrating a configuration example of a conventional planar antenna 103. The planar antenna 103 is a microstrip antenna for milliwave, in which a linear feed line 21 that allows a traveling wave to propagate and a substantially rectangular radiating element 22P that is excited by the traveling wave are formed on a dielectric substrate. The radiating element 22P is arranged such that an element length La is made substantially equal to λg/2 (λg is a wavelength of the traveling wave) and a direction of the element length La is inclined with respect to the feed line 21. For example, a linearly polarized wave of which a polarization plane is inclined with respect to the feed line 21 at an angle of 45° can be radiated.

However, in this planar antenna 103, one vertex of the radiating element 22P is connected to the feed line 21, and through the vertex, electricity is fed, and therefore there exists a problem that as an element width Lb is brought close to λg/2, a degenerate mode occurs. That is, as the element width Lb is brought close to λg/2, not only a co-polarization wave having the polarization plane in the direction of the element length La, but also a cross polarized wave having a polarization plane in a direction of the element width Lb is radiated. For this reason, there exists a problem that a radiation wave from the planar antenna 103 is a synthetic wave of the co-polarization wave and the cross polarized wave, and a polarization plane thereof does not coincide with the direction of the element length La.

Accordingly, it is thought that by keeping the element width Lb away from λg/2, such degenerate mode is suppressed from occurring. For example, if the element width Lb is set to a value sufficiently smaller than λg/2, the cross polarized wave component can be ignored. However, radiation power by the radiating element 22P is determined by an impedance ratio between the feed line 21 and the radiating element 22P, and impedance of the radiating element 22P is determined by the element width Lb. For this reason, if the element width Lb is changed in order to suppress the cross polarized wave, the radiation power of the radiating element 22P is also changed correspondingly, and a desired radiation distribution cannot be obtained, so that there exists a problem that it is difficult to optimally design the microstrip antenna.

### SUMMARY OF THE INVENTION

The present invention is made in consideration of the above-described situations, and an object thereof is to suppress radiation of a cross polarized wave by a traveling wave excitation antenna to improve cross polarization discrimination of the traveling wave excitation antenna. In particular, the present invention is intended to provide a traveling wave excitation antenna that can, without changing an element width of a radiating element, suppress radiation of a cross polarized wave. Also, the present invention is intended to provide a highly efficient traveling wave excitation antenna.

Further, the present invention is intended to, in a planar antenna of which a co-polarization direction is inclined with respect to a feed line, suppress radiation of a cross polarized wave to improve cross polarization discrimination of a traveling wave excitation antenna. In particular, the present invention is intended to provide a planar antenna that can, without changing an element width of a radiating element, suppress radiation of a cross polarized wave. Also, the present invention is intended to provide a highly efficient planar antenna.

A traveling wave excitation antenna according to a first aspect of the present invention is a traveling wave excitation antenna wherein: a feed line through which a traveling wave propagates, and a radiating element that is excited by the traveling wave are formed on a dielectric substrate; and the radiating element has a radiating part for radiating a co-polarization wave, and an open stub that extends from the radiating part toward a cross polarization direction.

According to such a configuration, without changing an element width of the radiating part, i.e., without changing a length in the cross polarization direction, radiation of a cross polarized wave by the radiating element can be suppressed to improve cross polarization discrimination. Accordingly, without significantly deteriorating the cross polarization discrimination, the radiating element having a desired element width can be realized. By using such a radiating element, a traveling wave excitation antenna can be optimally designed to realize a highly efficient traveling wave excitation antenna.

A traveling wave excitation antenna according to a second aspect of the present invention is, in addition to the above configuration, configured such that the open stub has a stub length that is substantially equal to (2N+1)/4 wavelength of the traveling wave (where N is an integer). In general, as the element width of the radiating part is brought close to (2N+1)/2 wavelength of the traveling wave, the cross polarized wave is more likely to be radiated from the radiating element. Even in such a case, by setting the stub length of the open stub to (2N+1)/4 wavelength, a resonant length in the cross polarization direction, which is determined by the element width and the stub length, can be made substantially equal to (2N+1)/4 wavelength to suppress the cross polarized wave. That is, under the condition that allows the cross polarized wave to be easily radiated, the radiation of the cross polarized wave can be effectively suppressed. For this reason, regardless of the element width of the radiating part, predetermined cross polarization discrimination can be ensured.

A traveling wave excitation antenna according to a third aspect of the present invention is, in addition to the above configuration, configured such that the open stub is arranged substantially in the center of the radiating part in a co-polarization direction. In the radiating element, substantially in the center in the co-polarization direction, a node of an electric field standing wave appears to minimize electric field intensity. For this reason, by arranging the open stub substantially in the center in the co-polarization direction, the radiation of the cross polarized wave can be effectively suppressed to improve the cross polarization discrimination.

A planar antenna according to a fourth aspect of the present invention is a planar antenna provided with: a dielectric substrate on which a feeding point is formed; a feed line that is formed on the dielectric substrate and formed of a substantially linear microstrip line of which one end is connected to the feeding point; and a radiating element that is excited by a traveling wave that propagates through the feed line, wherein the radiating element has: a radiating part that has a co-polarization direction that has an angle with respect to the feed line, and is formed of a substantially rectangular strip piece that is fed with electricity from one vertex thereof; and an open stub that is formed of a strip piece that extends from the radiating part toward a cross polarization direction.

According to such a configuration, without changing an element width of the radiating part, radiation of a cross polarized wave by the radiating element can be suppressed to improve cross polarization discrimination. Accordingly, by using such a radiating element, a planar antenna in which a polarization plane of a co-polarization wave is inclined with respect to the feed line can be optimally designed to realize a highly efficient planar antenna.

A planar antenna according to a fifth aspect of the present invention is, in addition to the above configuration, configured such that the radiating element has an element length that is substantially equal to (2N+1)/2 wavelength of the traveling wave (where N is an integer); and the open stub has a stub length that is substantially equal to (2M+1)/4 wavelength of the traveling wave (where M is an integer).

In the traveling wave excitation antenna according to the present invention, the radiating element that is excited by the traveling wave has: the radiating part that radiates the co-polarization wave; and the open stub that extends toward the cross polarization direction. For this reason, the radiation of the cross polarized wave can be suppressed by the open stub. Accordingly, without changing the element width of the radiating part, the radiation of the cross polarized wave by the radiating element can be suppressed. By using such a radiating element, a traveling wave excitation antenna can be optimally designed to realize a highly efficient traveling wave excitation antenna.

In particular, by making the stub length of the open stub substantially equal to (2N+1)/4 wavelength of the traveling wave, regardless of the element width of the radiating part, predetermined cross polarization discrimination can be ensured.

Also, in the planar antenna according to the present invention, the radiating element has: the radiating part that has the co-polarization direction that has an angle with respect to the feed line, and is formed of the substantially rectangular strip piece that is fed with electricity from one vertex thereof and the open stub that is formed of a strip piece that extends from the radiating part toward the cross polarization direction. For this reason, without changing the element width of the radiating part, the radiation of the cross polarized wave by the radiating element can be suppressed to improve the cross polarization discrimination. Accordingly, by using such a radiating element, a planar antenna in which the polarization plane of the co-polarization wave is inclined with respect to the feed line can be optimally designed to realize a highly efficient planar antenna.

### BRIEF DESCRIPTION OF THE DRAWINGS

FIG. 1 is a perspective view illustrating a configuration example of a planar antenna 100 according to a first embodiment of the present invention;

FIG. 2 is a plan view illustrating an enlarged main part of the planar antenna 100 in FIG. 1;

FIG. 3 is an explanatory diagram of a method for suppressing the cross polarized wave using the open stub 22B in FIG. 2;

FIG. 4 is a diagram illustrating an example of directional characteristics of the radiating element 22 in FIG. 2;

FIG. 5 is a diagram illustrating directional characteristics of a conventional radiating element serving as a comparative example;

FIG. 6 is a diagram illustrating a relationship between the stub width Ld in the radiating element 22 in FIG. 2 and the cross polarization discrimination;

FIG. 7 is a diagram illustrating an example of disposition of the open stub 22B in FIG. 2;

FIG. 8 is a diagram illustrating a relationship between the position of the open stub 22B in FIG. 2 and the cross polarization discrimination;

FIG. 9 is a diagram respectively illustrating a configuration example of planar antenna 101 according to the present embodiment;

FIG. 10 is a diagram respectively illustrating a configuration example of planar antenna 102 according to the present embodiment;

FIG. 11 is a diagram illustrating an example of directional characteristics of the planar antenna 101 in FIG. 9;

FIG. 12 is a diagram illustrating directional characteristics of a conventional planar antenna serving as a comparative example;

FIG. 13 is a diagram illustrating an example of directional characteristics of the planar antenna 102 in FIG. 10;

FIG. 14 is a diagram illustrating directional characteristics of a conventional planar antenna serving as a comparative example;

FIG. 15 is a diagram illustrating another configuration example of the radiating element 22 according to the present invention;

FIG. 16 is a diagram illustrating still another configuration example of the radiating element 22 according to the present invention;

FIG. 17 is yet another configuration example of the radiating element 22 according to the present invention;

FIG. 18 is a diagram illustrating a configuration example of the radiating element 22 constituting the planar antenna according to the second embodiment of the present invention;

FIG. 19 is a cross-sectional view of the radiating element 22 along a C-C section line in FIG. 18;

FIG. 20 is a diagram illustrating another configuration example of the radiating element 22 according to the second embodiment of the present invention; and

FIG. 21 is a diagram illustrating a configuration of a main part of a conventional microstrip antenna.

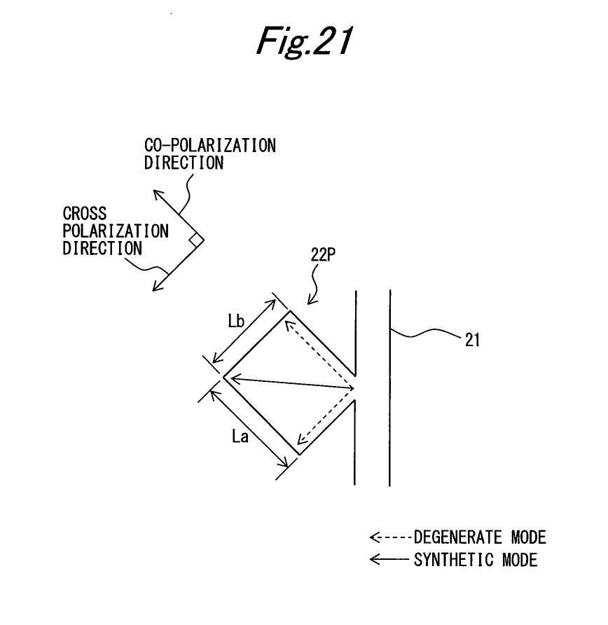

### DESCRIPTION OF PREFERRED EMBODIMENTS

### First Embodiment

### <Configuration of Planar Antenna 100>

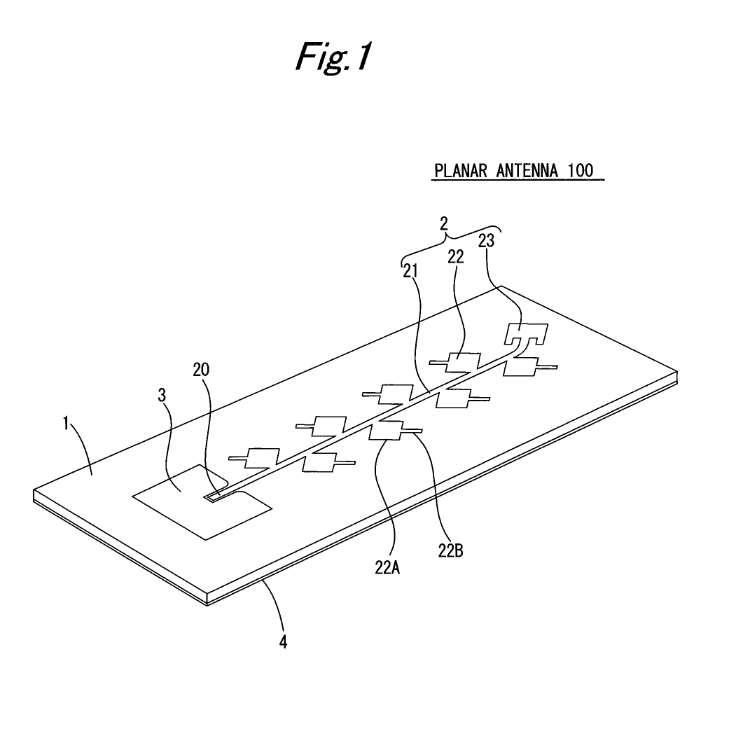

FIG. 1 is a perspective view illustrating a configuration example of a planar antenna 100 according to a first embodiment of the present invention. The planar antenna 100 is a microstrip antenna in which on both surfaces of a dielectric substrate 1, electrically conductive layers are formed, and by providing a radiating element 22 with an open stub 22B, suppresses radiation of a cross polarized wave by the radiating element 22 to improve cross polarization discrimination.

The dielectric substrate 1 is a substrate made of fluorine resin containing inorganic fibers, and formed in a tabular and substantially rectangular shape. On the front surface of the dielectric substrate 1, an antenna pattern 2 and converter pattern 3 formed by etching electrically conductive metallic foil are provided. Also, on the back surface of the dielectric substrate 1, a grounding plate 4 that almost covers a whole of the surface and is made of electrically conductive metal is provided, and the antenna pattern 2 and the grounding plate 4 are arranged so as to face to each other with sandwiching the dielectric substrate 1.

The antenna pattern 2 includes: a substantially linear feed line 21; a plurality of radiating elements 22 that are arranged along the feed line 21; and a matching element 23 that is provided at an open end toward which the feed line 21 is bent.

The feed line 21 is formed in a linear elongated shape that is configured to extend with keeping a constant width, and at one end thereof, a feeding point 20 is formed, whereas to the other end thereof, the matching element 23 is connected. Also, along both lateral sides of the feed line 21, the plurality of radiating elements 22 are placed. The matching element 23 is a well-known element that is connected to the terminal part of the feed line 21 not to reflect residual power at the open end of the feed line 21. On the basis of such a configuration, a high frequency wave that is fed from the feeding point 20 to the feed line 21 becomes a traveling wave that propagates through the feed line 21 in one direction toward the matching element 23.

Each of the radiating elements 22 is an element that is excited by the traveling wave propagating through the feed line 21 and radiates power of the traveling wave toward free space. That is, the planar antenna 100 is a traveling wave excitation antenna in which the radiating elements 22 are excited by the traveling wave. Each of the radiating elements 22 is configured to have: a substantially rectangular radiating part 22A; and the open stub 22B that is formed in an elongated shape protruded from the radiating part 22A. The radiating part 22A is well-known radiating means for radiating a co-polarization wave, and by providing the open stub 22B for such a radiating part 22A, radiation of a cross polarized wave of which a polarization plane is orthogonal to that of the co-polarization wave is suppressed.

Also, the respective radiating elements 22 are arranged such that the planar antenna 100 serves as a linear polarization array antenna. That is, respective radiating elements 22 formed along the same one of the lateral sides of the feed line 21 face in the same direction, and arranged at intervals of an integral multiple of a wavelength λg. Also, respective radiating elements 22 formed along the opposite lateral side of the feed line 21 face in an opposite direction, and arranged at intervals of [λg×(2N+1)/2] (where N is any integer, and the same applies to the following). For this reason, radiation waves from all of the radiating elements 22 are electromagnetic waves all having the same phase and uniformed polarization plane in the free space, and therefore the planar antenna 100 can radiate a linear polarized wave. In addition, the wavelength λg is a wavelength of the traveling wave that propagates through the feed line 21, and has a preset value as a wavelength corresponding to a design frequency of the planar antenna 100.

The converter pattern 3 is a shorting plate that constitutes a waveguide-microstrip line converter, and terminates a waveguide (not illustrated) configured to face to the back surface of the dielectric substrate 1. One end of the feed line 21 is formed in a slit part of the converter pattern 3, and thereby electromagnetically connected to the waveguide to serve as the feeding point 20. Note that FIG. 1 illustrates an example of the planar antenna 100 provided with the waveguide-microstrip line converter; however, another feeding method can also be employed.

### <Details of Radiating Element 22>

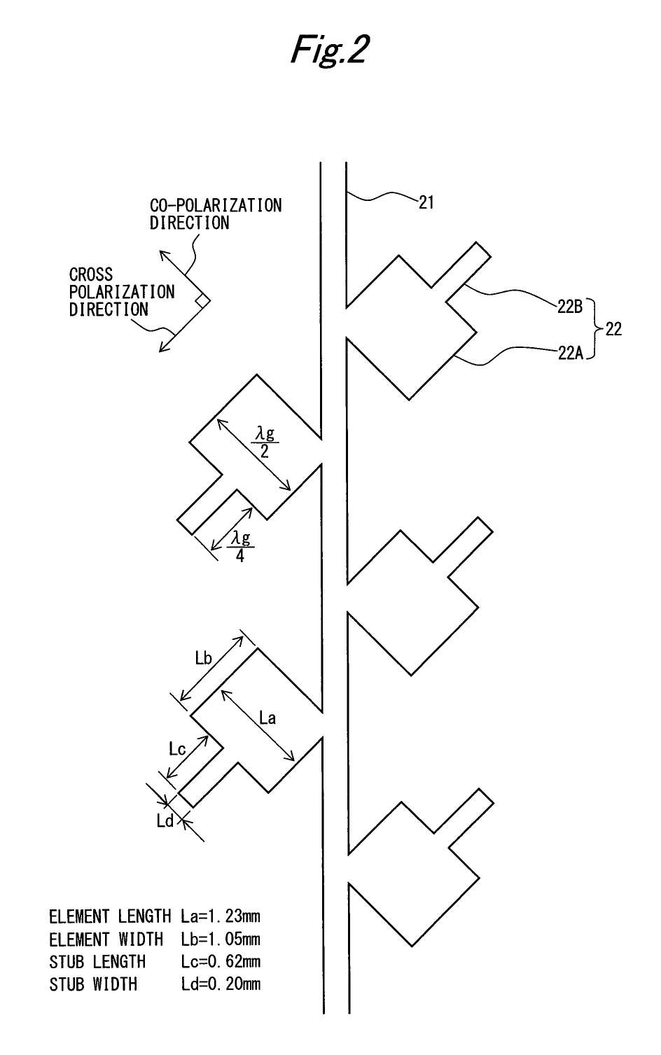

FIG. 2 is a plan view illustrating an enlarged main part of the planar antenna 100 in FIG. 1. With reference to FIG. 2, the radiating part 22A and open stub 22B constituting the radiating element 22 are described in detail below.

The radiating part 22A is formed of a substantially rectangular strip piece having an element length La and an element width Lb; arranged with being inclined with respect to the feed line 21; has one vertex that is connected to the feed line 21; and fed with electricity from the feed line 21 through the vertex. In the present embodiment, the one vertex of the radiating part 22A is connected to the feed line 21 as a pattern; however, the radiating part 22A is only required to be electromagnetically connected to the feed line 21, but not necessarily connected as a pattern.

The radiating part 22A is excited by the traveling wave having the wavelength λg by making the element length La substantially equal to [λg/2×(2N+1)]. In this case, a direction of the element length La coincides with a co-polarization direction, and therefore if the radiating part 22A is arranged with being inclined with respect to the feed line 21, the co-polarization direction can be inclined with respect to the feed line 21. In the present embodiment, the element length La is set to 1.23 mm that is substantially equal to λg/2, and the radiating part 22A is arranged with being inclined such that the direction of the element length La forms an angle of 45° with respect to the feed line 21, so that the co-polarization direction of the radiating element 22 has an angle of 45° with respect to the feed line 21.

The element width Lb is determined depending on radiation efficiency required for the radiating element 22. Impedance of the radiating element 22 takes a value depending on the element width Lb, and excitation amplitude depending on the impedance can be obtained. For this reason, by controlling the element width Lb, radiation power of the radiating element 22 can be controlled. In short, by increasing the element width Lb, the radiation efficiency can be increased, whereas by decreasing the element width Lb, the radiation efficiency can be decreased. In the present embodiment, the element width Lb is assumed to be 1.05 mm.

The open stub 22B is a stub of which one end is connected to the radiating part 22A and the other end is opened, and formed in an elongated and substantially rectangular shape that extends toward a cross polarization direction. Also, substantially in the center of the co-polarization direction, the open stub 22B is connected to a circumferential edge part of the radiating part 22A. In the present embodiment, the one end of the open stub 22B is connected to the radiating part 22A as a pattern; however, the open stub 22B is only required to be electromagnetically connected to the radiating part 22A, but not necessarily connected as a pattern.

The open stub 22B suppresses radiation of a cross polarized wave by the radiating part 22A to improve cross polarization discrimination by making a stub length Lc substantially equal to [λg/4×(2N+1)]. In the present embodiment, the stub length Lc is assumed to be 0.62 mm that is substantially equal to λg/4. Also, a stub width Ld is assumed to be 0.20 mm.

If the element width Lb of the radiating part 22A has a value that is sufficiently small as compared with λg/2, a cross polarization component radiated by the radiating part 22A is sufficiently small as compared with a co-polarization component, and therefore high cross polarization discrimination is obtained. However, as the element width Lb is brought close to λg/2, influence of the cross polarization component becomes unignorable. Even in such a case, by providing the open stub 22B of which the stub length Lc is substantially equal to λg/4, a resonant length in the cross polarization direction, which is determined by the radiating part 22A and the open stub 22B, can be made substantially equal to [λg×3/4]. For this reason, the cross polarization component can be suppressed.

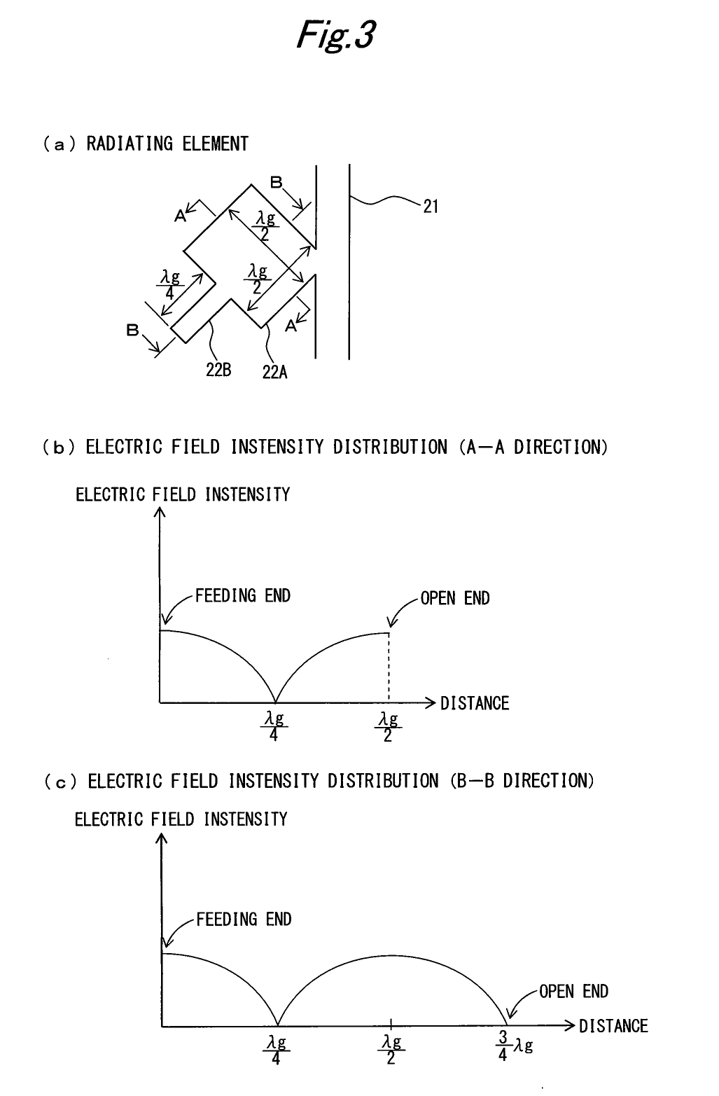

FIG. 3 is an explanatory diagram of a method for suppressing the cross polarized wave using the open stub 22B in FIG. 2. (b) and (c) in the diagram are diagrams schematically illustrating electric field intensity distributions in the radiating element 22 having La=Lb=λg/2 and Lc=λg/4 illustrated in (a), in which (b) illustrated an electric field intensity distribution in an A-A direction, and (c) illustrates an electric field intensity distribution in a B-B direction. In any of them, the horizontal axis represents a distance from a feeding end of the radiation element 22 whereas the vertical axis represents electric field intensity, and a one-dimensional electric field intensity distribution is schematically illustrated.

In the case where the element length La is equal to λg/2, the A-A direction coincides with the co-polarization direction. That is, the electric field intensity distribution in which in the A-A direction of the radiating part 22A, the center act as a node of an electric field standing wave and the feeding end and open end act as antinodes of the electric field standing wave is formed, and a radio wave having a polarization plane in the co-polarization direction is radiated.

Similarly, in the case where the element width Lb is equal to λg/2, the electric field distribution in which in the B-B direction as well, the center of the radiating part 22A act as a node of the electric field standing wave, and both ends act as antinodes of the electric field standing wave is formed. However, the open end of the radiating part 22A is added with the open stub 22B having the stub length λg/4, so that the distance from the feeding side to the open end becomes λg×3/4, and therefore at the open end, a node of the electric field standing wave appears. For this reason, radiation of a radio wave having a polarization plane in the cross polarization direction can be suppressed.

### <Directional Characteristics of Radiating Element 22>

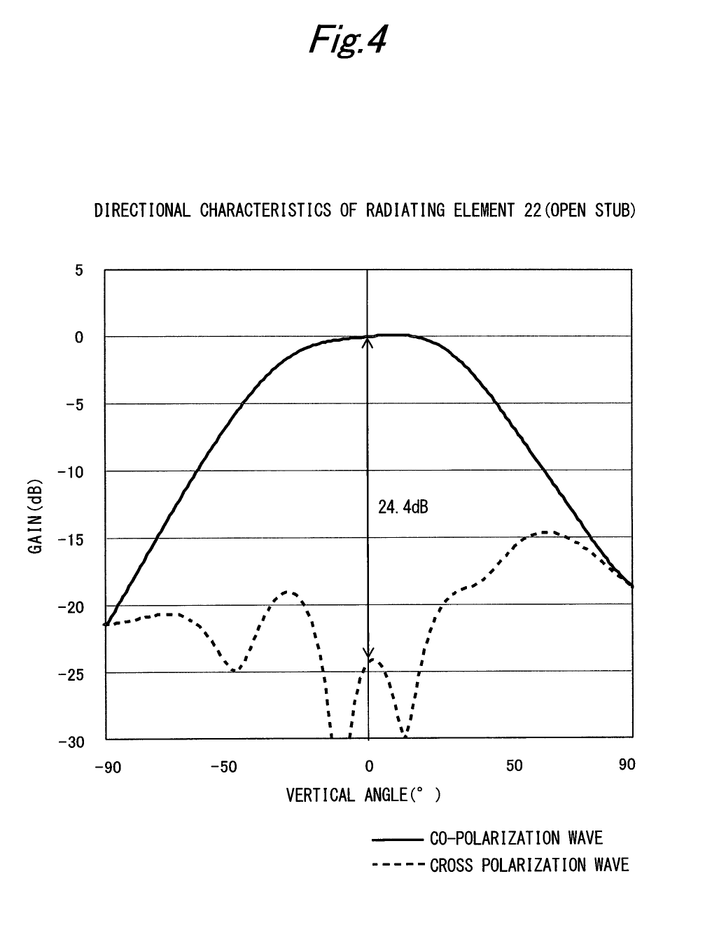

FIG. 4 is a diagram illustrating an example of directional characteristics of the radiating element 22 in FIG. 2, in which illustrated are results of, through simulation, obtaining directional characteristics in an extending direction of the feed line 21 in terms of respective gains of the co-polarization wave and cross polarized wave that are radiated from a single body of the radiating element 22. A gain represented by the vertical axis is provided with being normalized by the gain of the co-polarization wave in a front direction, and a vertical angle represented by the horizontal axis is an angle in an up-and-down direction for the case of arranging the planar antenna so as to orient the feed line 21 in the vertical direction. Also, the radiating element 22 used for the simulation is assumed to have the element length La=1.23 mm, element width Lb=1.05 mm, and stub length Lc=0.62 mm, and also have the co-polarization direction having an angle of 45° with respect to the feed line 21.

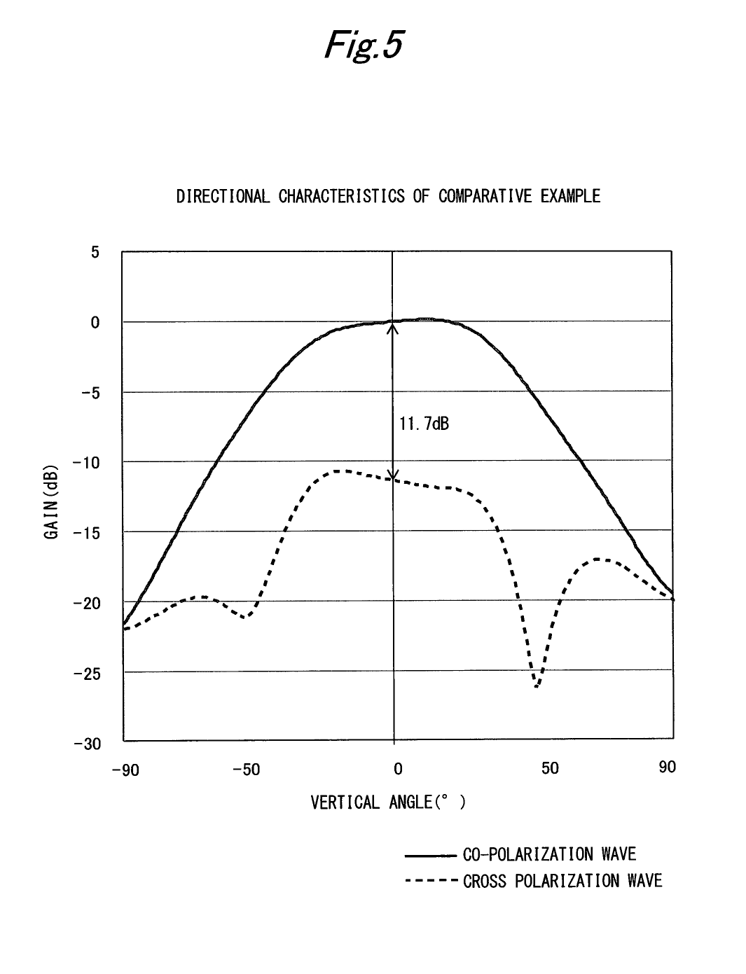

FIG. 5 is a diagram illustrating directional characteristics of a conventional radiating element serving as a comparative example, in which illustrated as in FIG. 4 are directional characteristics of co-polarized and cross polarized waves of the radiating element that is, as compared with the radiating element 22 in FIG. 2, different only in the point of not having the open stub 22B.

The cross polarization discrimination is given as a ratio between the co-polarization component and the cross polarization component. The cross polarization discrimination in the front direction is 24.4 dB in the radiating element 22 according to the present embodiment in FIG. 4, whereas in the conventional radiating element in FIG. 5, it is 11.7 dB. Therefore, it turns out that by providing the open stub 22B, the radiation of the cross polarized wave is suppressed to significantly improve the cross polarization discrimination.

### <Width of Open Stub 22B>

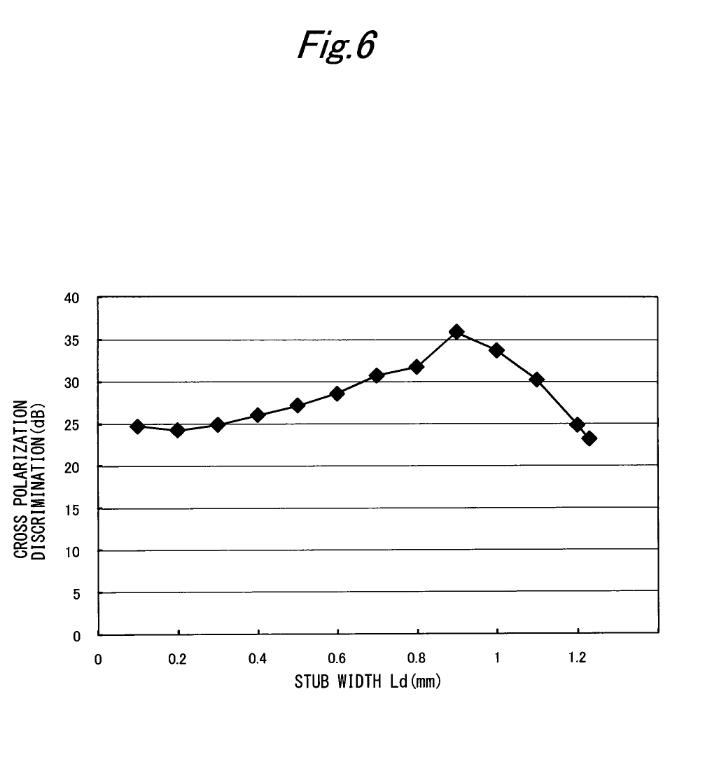

FIG. 6 is a diagram illustrating a relationship between the stub width Ld in the radiating element 22 in FIG. 2 and the cross polarization discrimination, in which illustrated is a result of, through simulation, obtaining the cross polarization discrimination for the case of setting the stub width Ld of the substantially rectangular open stub 22B in a single body of the radiating element 22 to 0.1 mm to 1.23 mm. Note that, in the case of the width of 1.23 mm, the stub width Ld coincides with the element length La, so that the case can no longer be said to correspond to a configuration provided with the open stub 22B but correspond to the conventional radiating element.

In the range equal to or less than 0.9 mm, as the stub width Ld is increased, the cross polarization discrimination increases, whereas in the range equal to or more than 0.9 mm, as the stub width Ld is increased, the cross polarization discrimination decreases. That is, when the stub width Ld is approximately 0.9 mm, the cross polarization discrimination is maximized. It turns out that, in particular, when the stub width Ld is in the range not less than λg/4 and less than λg/2, particularly good cross polarization discrimination can be obtained.

In the case of attempting to improve the cross polarization discrimination without providing the open stub 22B, it is thought that the element width Lb of the radiating part 22A is increased and made substantially equal to 3/4λg. That is, this corresponds to the case where the stub width Ld in the diagram is 1.23 mm. In this case, as compared with the case where the open stub 22B having the stub width of 0.1 mm to 1.2 mm, only low cross polarization discrimination can be obtained. Further, there also occurs a problem that a radiation width is increased, and whereby the impedance of the radiating element 22 is increased to change the radiation efficiency. On the other hand, by providing the open stub 22B, the cross polarization component can be suppressed without remarkably changing the impedance of the radiation element 22. In addition, the stub width Ld is appropriately determined so as to be smaller than the element length La of the radiating part 22A by comparing and balancing influence on the impedance of the radiating element 22 and influence on the cross polarization discrimination, which are given by the open stub 22B, with each other.

### <Disposition of Open Stub 22B>

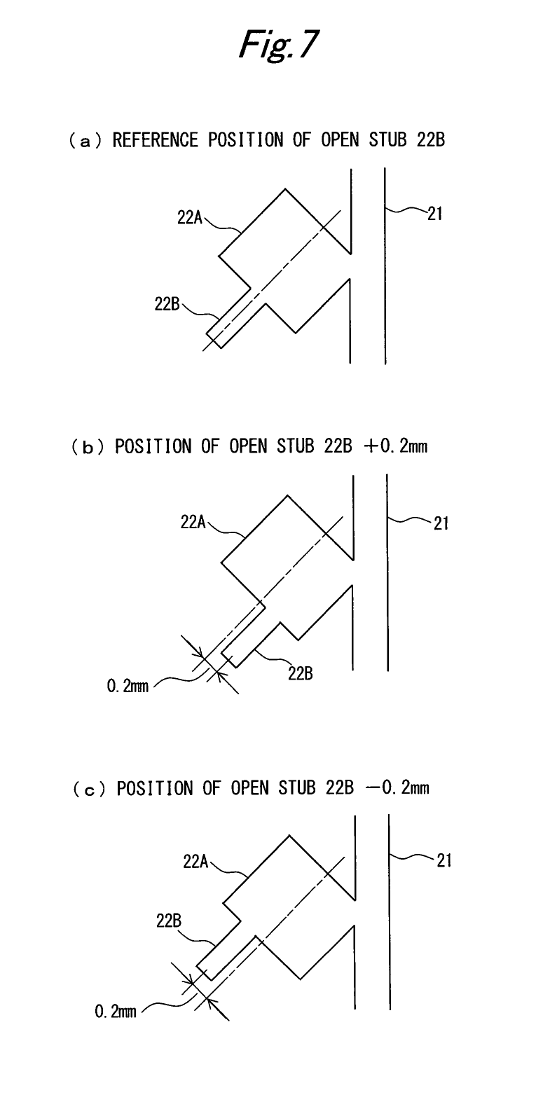

FIG. 7 is a diagram illustrating an example of disposition of the open stub 22B in FIG. 2, in which examples where a position of the open stub 22B is changed in the co-polarization direction are illustrated. (a) in the diagram illustrates the case where as in FIG. 2, the open stub 22B is disposed in the center (reference position) of the radiating part 22A in the co-polarization direction. Also, (b) illustrates the case where the open stub 22B is disposed at a position (+0.2 mm) that is sifted from the reference position toward the feeding end side by 0.2 mm, and (c) illustrates the case where the open stub 22B is disposed at a position (−0.2 mm) that is shifted from the reference position toward the open end side by 0.2 mm. Here, for convenience, it is assumed that a position of the open stub 22B is represented by a signed shift amount from the reference position, and the sign is a plus sign, toward the feeding end side, whereas toward the open end side, it is a minus sign.

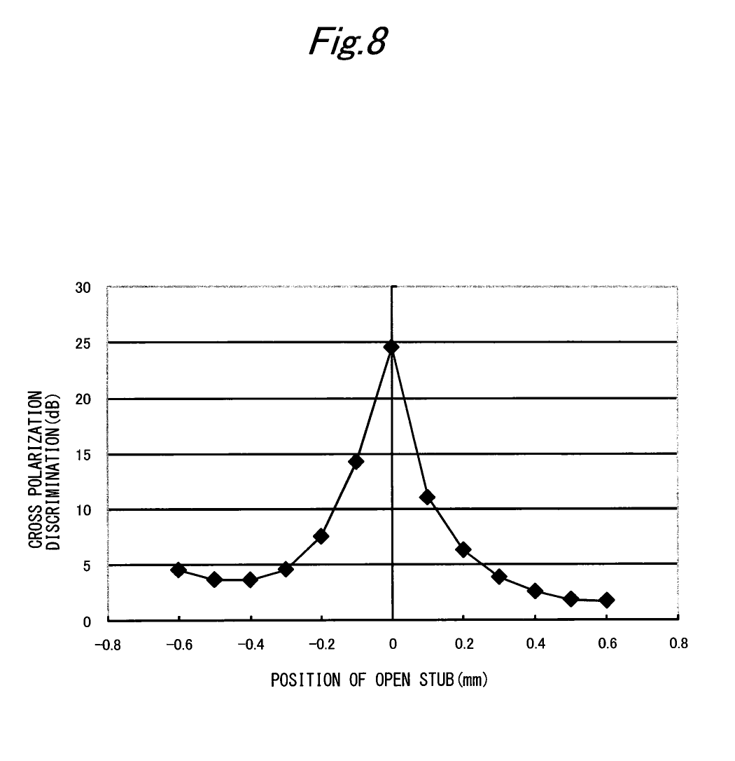

FIG. 8 is a diagram illustrating a relationship between the position of the open stub 22B in FIG. 2 and the cross polarization discrimination, in which illustrated is a result of, through simulation, obtaining the cross polarization discrimination of a single body of the radiating element 22 for the case of, as illustrated in FIG. 7, changing the position of the open stub 22B in the co-polarization direction. From the result, it turns out that by disposing the open stub 22B substantially in the center of the radiating part 22A in the co-polarization direction, good cross polarization discrimination can be obtained.

Regarding the electric field intensity distribution in the co-polarization direction in the radiating part 22A, as illustrated in FIG. 3 (b), both ends act as antinodes of an electric field standing wave, and the center acts as a node of the electric field standing wave. Therefore, it is thought that by disposing the open stub 22B substantially in the center in the co-polarization direction, the radiation of the cross polarized wave can be effectively suppressed.

### <Characteristics of Planar Antennas 101 and 102>

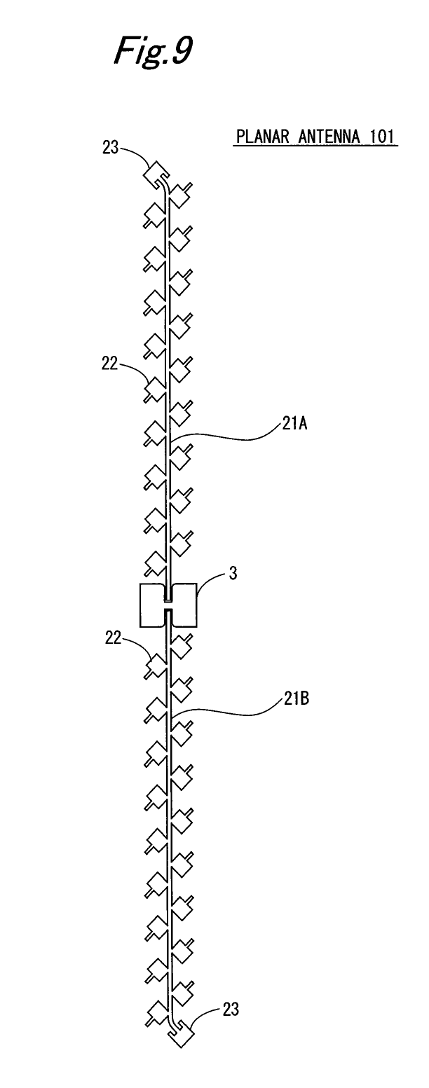

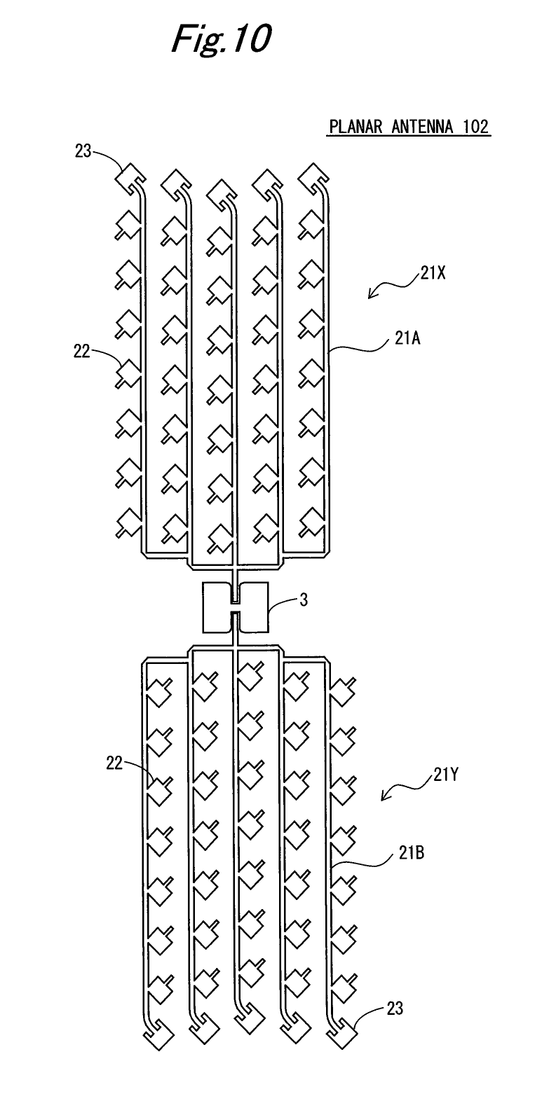

FIGS. 9 and 10 are diagrams respectively illustrating one configuration examples of planar antennas 101 and 102 according to the present embodiment. The planar antenna 101 in FIG. 9 is an array antenna that is provided with a pair of feed lines 21A and 21B. The respective feed lines 21A and 21B extend from a common converter pattern 3 serving as a feeding point toward directions opposite to each other, and along both lateral sides thereof, a number of radiating elements 22 are respectively formed. Also, at open ends, matching elements 23 are provided.

The planar antenna 102 in FIG. 10 is an array antenna that is provided with a pair of feed line groups 21X and 21Y. The respective feed line groups 21X and 21Y are arranged with placing a common converter pattern 3 serving as a feeding point therebetween. The feed line group 21X includes a plurality of mutually parallel feed lines 21A, and the feed line group 21Y includes a plurality of mutually parallel feed lines 21B. Also, the feed lines 21A and the feed lines 21B extend toward directions opposite to each other. That is, the planar antenna 102 has a configuration in which the feed lines 21A and 21B in the planar antenna 101 in FIG. 9 are respectively replaced by the pluralities of feed lines 21A and 21B. Note that radiating elements 22 are formed only along one lateral side of each of the feed lines 21A and 21B.

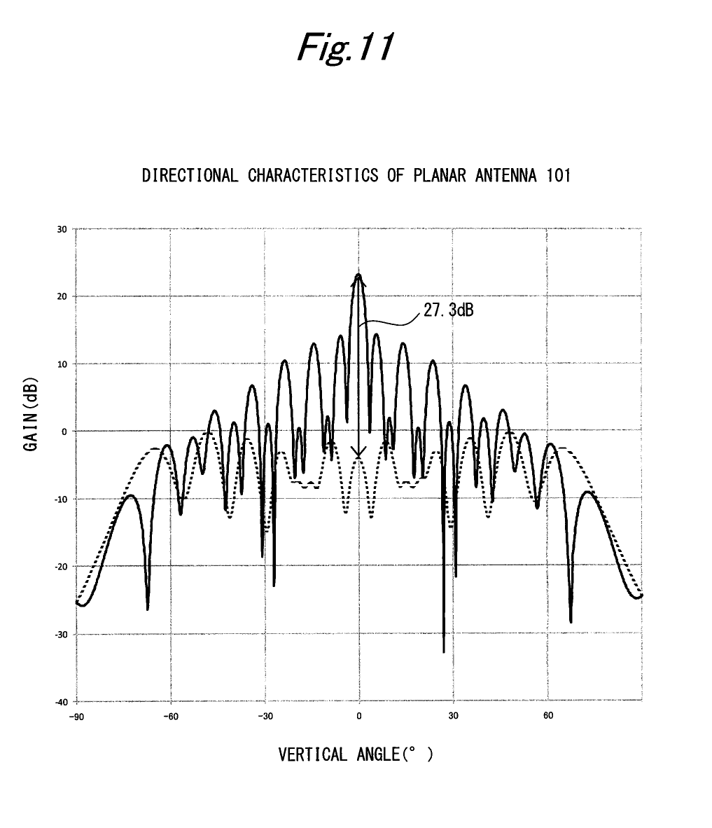

FIG. 11 is a diagram illustrating an example of directional characteristics of the planar antenna 101 in FIG. 9, in which illustrated are results of, through simulation, obtaining directional characteristics in extending directions of the feed lines 21A and 21B in terms of respective gains of co-polarized and cross polarized waves that are radiated from the planar antenna 101. A vertical angle represented by the horizontal axis is an angle in an up-and-down direction for the case of arranging the planar antenna 101 so as to orient the feed lines 21A and 21B in the vertical direction. From this diagram, it turns out that the cross polarization discrimination of the planar antenna 101 in the front direction is 27.3 dB.

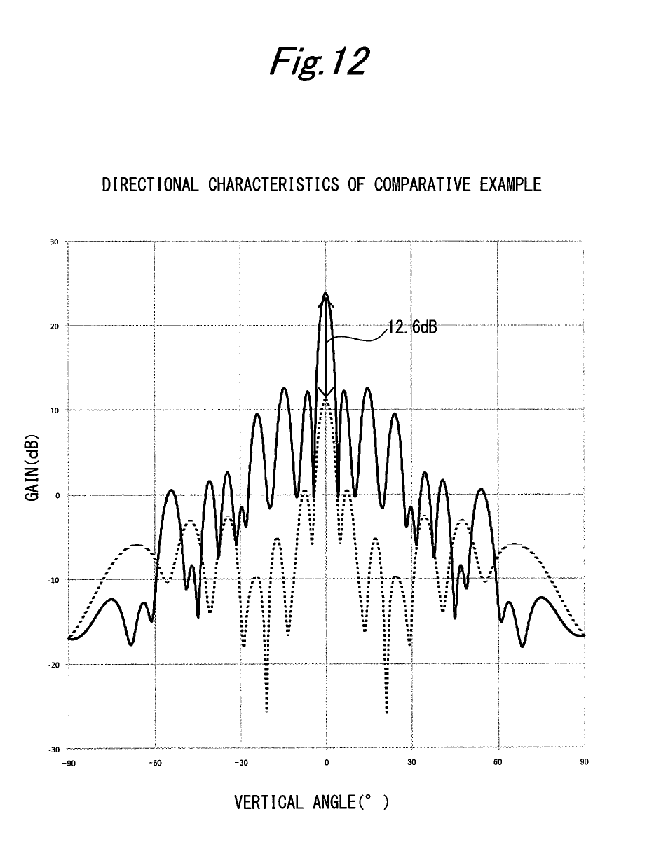

FIG. 12 is a diagram illustrating directional characteristics of a conventional planar antenna serving as a comparative example, in which illustrated as in FIG. 11 are directional characteristics of co-polarized and cross polarized waves of the planar antenna that is, as compared with the planar antenna 101 in FIG. 9, different only in that any of radiating elements 22 does not have the open stub 22B. In the diagram, the cross polarization discrimination in the front direction is 12.6 dB. Accordingly, if the cross polarization discrimination in FIG. 11 and that in FIG. 12 are compared with each other, it turns out that in the planar antenna 101 in FIG. 9, by providing the open stubs 22B, the cross polarized wave is suppressed to significantly improve the cross polarization discrimination.

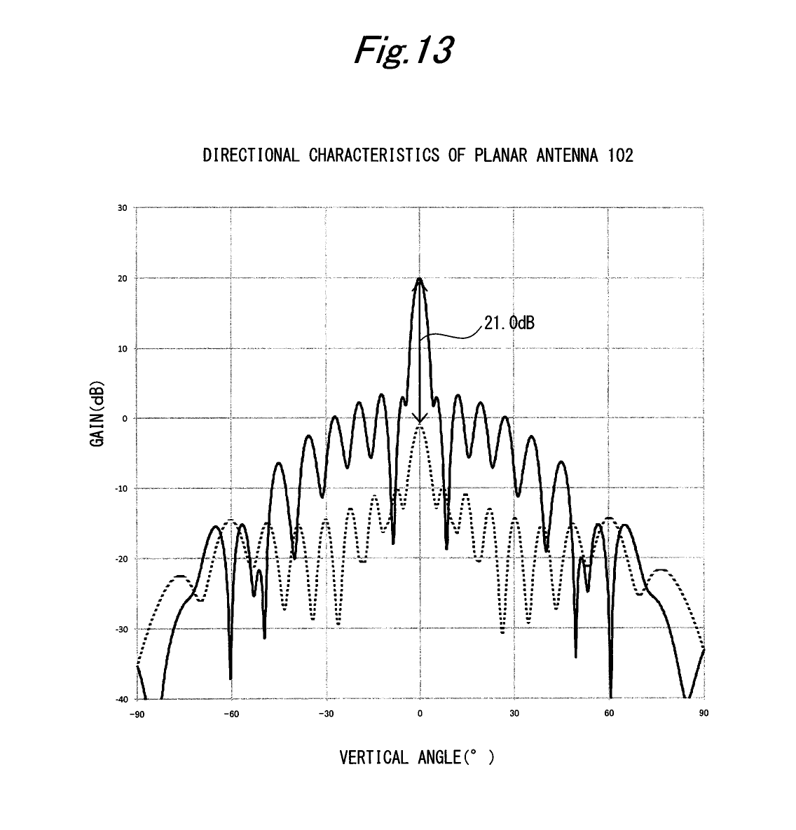

FIG. 13 is a diagram illustrating an example of directional characteristics of the planar antenna 102 in FIG. 10, in which illustrated are results of, through simulation, obtaining directional characteristics in extending directions of the feed lines 21A and 21B in terms of respective gains of co-polarized and cross polarized waves that are radiated from the planar antenna 102. A vertical angle represented by the horizontal axis is an angle in an up-and-down direction for the case of arranging the planar antenna 102 so as to orient the feed lines 21A and 21B in the vertical direction. From this diagram, it turns out that the cross polarization discrimination of the planate antenna 102 in the front direction is 21.0 dB.

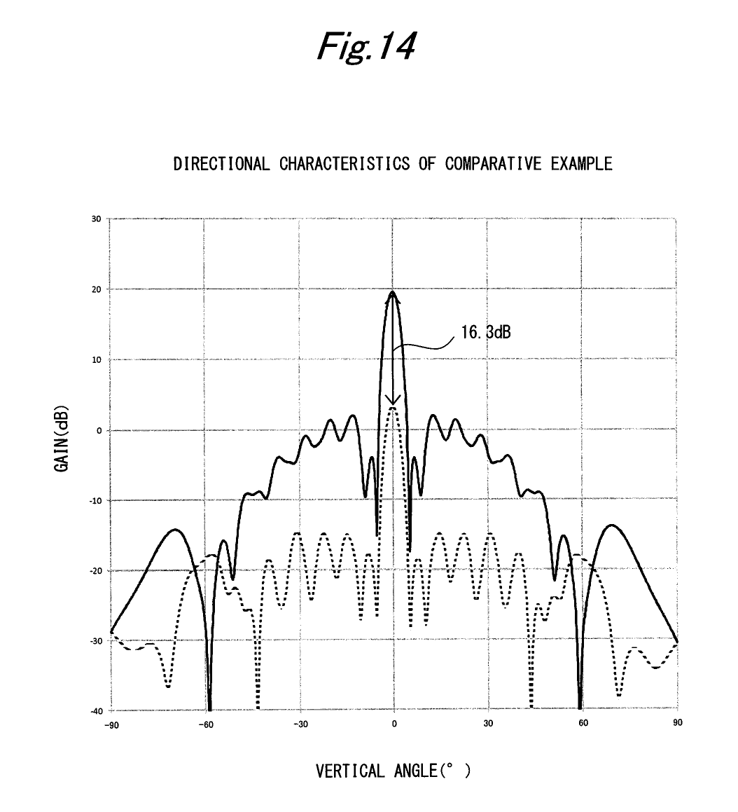

FIG. 14 is a diagram illustrating directional characteristics of a conventional planar antenna serving as a comparative example, in which illustrated as in FIG. 13 are directional characteristics of co-polarized and cross polarized waves of the planar antenna that is, as compared with the planar antenna 102 in FIG. 10, different only in that any of radiating elements 22 does not have the open stub 22B. In the diagram, the cross polarization discrimination in the front direction is 16.3 dB. Accordingly, if the cross polarization discrimination in FIG. 13 and that in FIG. 14 are compared with each other, it turns out that even in the planar antenna 102 in FIG. 10, by providing the open stubs 22B, the cross polarized wave is suppressed to significantly improve the cross polarization discrimination.

In any of the planar antennas 100 to 102 according to the present embodiment, the feed line(s) 21 through which the traveling wave(s) propagates and the radiating elements 22 excited by the traveling wave(s) are formed on the dielectric substrate 1, and each of the radiating elements 22 has: the radiating part 22A for radiating the co-polarization wave; and the open stub 22B extending from the radiating part 22A toward the cross polarization direction. By employing such a configuration, without changing the element width Lb of the radiating part 22A, the radiation of the cross polarized wave by the radiating element 22 can be suppressed to improve the cross polarization discrimination. Accordingly, without significantly deteriorating the cross polarization discrimination, the radiating element 22 having a desired element width Lb can be realized. Also, by using such a radiating element 22, a desired radiation distribution can be obtained, so that a planar antenna can be optimally designed to realize a highly efficient planar antenna.

Also, in any of the planar antennas 100 to 102 according to the present embodiment, the stub length Lc of the open stub 22B is made substantially equal to [λg/2×(2N+1)]. For this reason, even in the case where the element width Lb of the radiating part 22A is substantially equal to [λg/4×(2N+1)], the resonant length in the cross polarization direction, which is determined by the element width Lb and the stub length Lc, can be made substantially equal to [λg/4×(2N+1)] to suppress the cross polarized wave. For this reason, without changing the element width Lb of the radiating part 22A, predetermined cross polarization discrimination can be ensured.

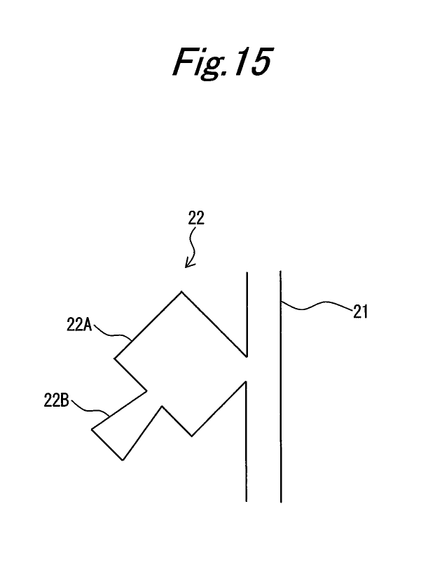

Note that, in the present embodiment, described is an example of the case where the open stub 22B is formed in the substantially rectangular shape; however, the present invention is not limited only to such a case. That is, if the open stub 22B has a predetermined stub length Lc in the cross polarization direction, a shape thereof may not be the substantially rectangular shape. FIG. 15 is a diagram illustrating another configuration example of the radiating element 22 according to the present invention. A radiating element 22 in the diagram is provided with a substantially triangular open stub 22B; however, even in such a configuration, the same effect as that for the case of providing the substantially rectangular open stub 22B can be obtained.

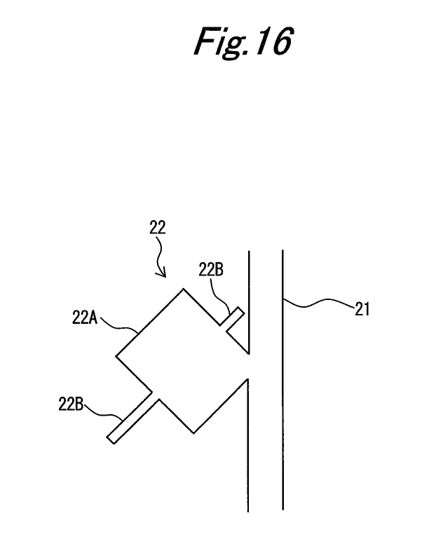

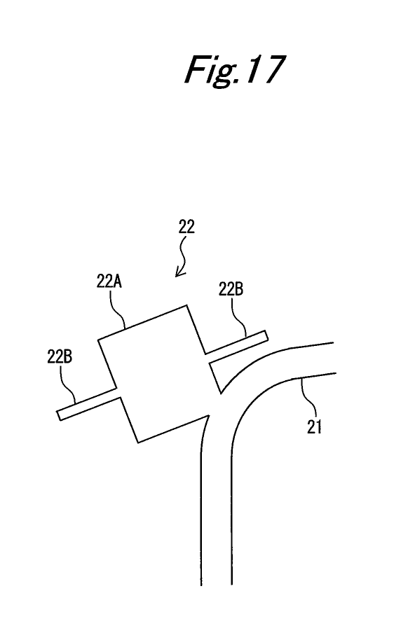

Also, in the present embodiment, described is an example of the case where at the open end of the radiating part 22A in the cross polarization direction, the open stub 22B is provided; however, the present invention is not limited only to such a case. That is, the open stub 22B can also be provided at the feeding end in the cross polarization direction. Further, at both of the open end and feeding end in the cross polarization direction, the open stubs 22B can also be provided. FIG. 16 is a diagram illustrating still another configuration example of the radiating element 22 according to the present invention. In a radiating element 22 in the diagram, a pair of open stubs 22B is formed with placing the radiating part 22A therebetween in the cross polarization direction, and the open stub 22B provided at the feeding end is formed with being separated from the feed line 21. FIG. 17 is yet another configuration example of the radiating element 22 according to the present invention. In a radiating element 22 in the diagram, as in the case of FIG. 16, a pair of open stubs 22B is formed with placing the radiating part 22A therebetween; however a stub length of the open stub 22B on the feeding end side is longer than that for the case of FIG. 16. For this reason, to prevent the open stub 22B from being connected to the feed line 21, the feed line 21 is bent to separate the both from each other. Even in a configuration as illustrated in FIG. 16 or 17, the same effect can be obtained if a sum of lengths of the two open stubs 22B in the cross polarization direction meets [λg/4×(2N+1)].

Also, in the present embodiment, described is an example of the case where the stub length Lc of the open stub 22B is made substantially equal to [λg/4×(2N+1)]. By employing such a configuration, regardless of the element width Lb of the radiating part 22A, the cross polarized wave can be suppressed. However, the present invention is not limited only to such a case. For example, the length of the open stub 22B can also be determined such that a length in the cross polarization direction, which is determined by the element width Lb and the stub length Lc, becomes substantially equal to [λg/4×(2N+1)]. That is, the stub length Lc can also be determined depending on the element width Lb.

Further, in the above-described embodiment, described is an example of the case where all of the radiating elements 22 constituting any of the planar antennas 100 to 102 are each provided with the open stubs 22B; however the present invention is not limited only to such a case. For example, in the case of a planar antenna in which radiating elements 22 having different element widths Lb are formed, only some radiating elements 22 that are likely to radiate cross polarized waves because their element widths Lb are close to [λ/2×(2N+1)] can also be provided with the open stubs 22B.

### Second Embodiment

In the first embodiment, described are the planar antennas 100 to 102 each of which suppresses the cross polarized wave by using the radiating element 22 having the open stub 22B extending in the cross polarization direction. On the other hand, in the present invention, described is a planar antenna that suppresses a cross polarized wave by using a radiating element 22 having a short stub 22C at one end in a cross polarization direction.

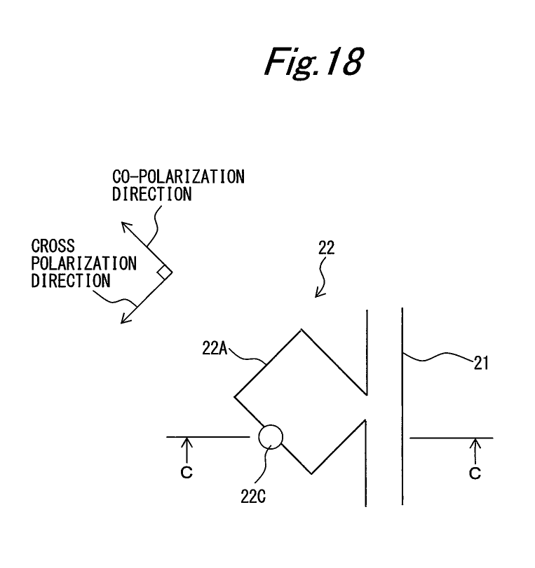

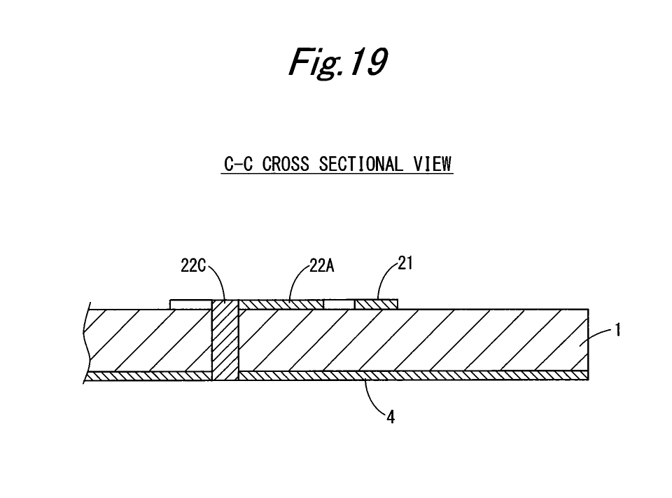

FIG. 18 is a diagram illustrating a configuration example of the radiating element 22 constituting the planar antenna according to the second embodiment of the present invention. Also, FIG. 19 is a cross-sectional view of the radiating element 22 along a C-C section line in FIG. 18. The radiating element 22 according to the present embodiment is, as compared with the radiating element in FIG. 2, different in that in place of the open stub 22B, the short stub 22C is provided.

The radiating element 22 is configured to have a substantially rectangular radiating part 22A and the short stub 22C formed in a circumferential edge part of the radiating part 22A. The radiating part 22A is the same as that illustrated in FIG. 2, and therefore redundant description is omitted. The short stub 22C is formed of a through-hole that is formed at one end of the radiating part 22A in the cross polarization direction and substantially in the center of the radiating part 22A in a co-polarization direction. The through-hole is formed by filling electrically conductive metal in a through-hole formed through a dielectric substrate 1, and electrically conducts between the radiating part 22A and a grounding plate 4 formed on a back surface of the dielectric substrate 1 to each other.

By forming the short stub 22C at one end of the radiating element 22 in the cross polarization direction, electric field intensity at the one end is fixed to a ground level. For this reason, an electric field intensity distribution in the radiating element 22 in the cross polarization direction is a distribution in which the one end constantly acts as a node of an electric field standing wave, and therefore radiation of the cross polarized wave can be suppressed. Note that, in order to prevent the short stub 22C from adversely influencing radiation of a co-polarization wave, the short stub 22C is required to be arranged substantially in the center of the radiating element 22 in the co-polarization direction.

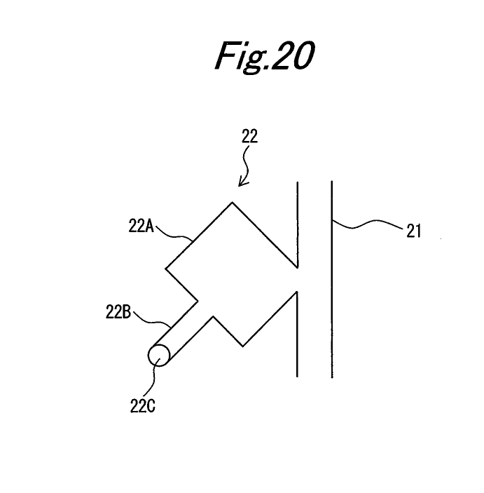

FIG. 20 is a diagram illustrating another configuration example of the radiating element 22 according to the second embodiment of the present invention. In a radiating element 22 in the diagram, in the same manner as that for the case of the first embodiment, a stub extending from the radiating part 22A toward the cross polarization direction is formed, and at a fore end of the stub, the short stub 22C is formed.

In order to suppress the radiation of the cross polarized wave using the short stub 22C, it is only necessary that the short stub 22C is formed at one end of the radiating element 22 in the cross polarization direction, and one end of an electric field intensity distribution of the radiating element 22 in the cross polarization direction acts as a node of an electric field standing wave. For this reason, even if the stub extending from the radiating part 22A toward the cross polarization direction is formed in the same manner as that for the case of the first embodiment, and at an open end of the stub, the short stub 22C is provided, the same effect can be obtained.

1. A traveling wave excitation antenna comprising:
a feed line through which a traveling wave propagates, and a radiating element that is excited by said traveling wave are formed on a dielectric substrate; and
said radiating element has a radiating part for radiating a co-polarized wave, and an open stub that extends from said radiating part toward a cross polarization direction.

2. The traveling wave excitation antenna according to claim 1, wherein
said open stub has a stub length that is substantially equal to (2N+1)/4 wavelength of said traveling wave (where N is an integer).

3. The traveling wave excitation antenna according to claim 1, wherein
said open stub is arranged substantially in a center of said radiating part in a co-polarization direction.

4. The traveling wave excitation antenna according to claim 1, wherein:
a feeding point is formed on said dielectric substrate;
said feed line is formed of a substantially linear microstrip line of which one end is connected to said feeding point; and
said radiating part has a co-polarization direction that has an angle with respect to said feed line, and is formed of a substantially rectangular strip piece that is fed with electricity from one vertex thereof.

5. The traveling wave excitation antenna according to claim 4, wherein:
said radiating element has an element length that is substantially equal to (2N+1)/2 wavelength of said traveling wave (where N is an integer); and
said open stub has a stub length that is substantially equal to (2M+1)/4 wavelength of said traveling wave (where M is an integer).
